(19) United States
(12) Patent Application Publication
(10) Pub. No.: US 2022/0034497 A1
(43) Pub. Date: Feb. 3, 2022

(54) LIGHT EMITTING HEAT DISSIPATING STRUCTURE

(71) Applicant: EXPOSURE ILLUMINATION ARCHITECTS, INC., Scottsdale, AZ (US)

(72) Inventor: Daniel S. Spiro, Scottsdale, AZ (US)

(21) Appl. No.: 17/505,052

(22) Filed: Oct. 19, 2021

Related U.S. Application Data
(63) Continuation-in-part of application No. 16/821,792, filed on Mar. 17, 2020, now Pat. No. 11,149,936.
(60) Provisional application No. 62/977,994, filed on Feb. 18, 2020.

(51) Int. Cl. F21V 29/70

(52) U.S. Cl. CPC F21V 29/70; F21Y 2105/10

(57) ABSTRACT

A light emitting heat dissipating structure form configured to improve light emission coverage and uniformity and save energy.

### CROSS-REFERENCE TO RELATED APPLICATIONS

This application is a continuation-in-part of a co-pending U.S. patent application Ser. No. 16/821,792, filed Mar. 17, 2020, that claims benefit to and priority from U.S. Provisional Patent Application, Ser. No. 62/977,994, filed Feb. 18, 2020. The disclosures of each of the above-mentioned applications are hereby incorporated by reference herein in their entireties.

### BACKGROUND

Improved efficiencies in solid state lighting (SSL), lighting optical controls, and photovoltaic power production challenge the architecture of today's outdoor luminaires' form factor. For roadway and area illumination, the present art most commonly couples SSL light sources to a retaining surface disposed at the bottom of the luminaire. Aside from directing light from the luminaire's bottom side, the luminaire's form factor does not incorporate other surfaces in emitting the light.

An optical lens placed over the light source directs the light toward areas below. The optical lens is commonly made of borosilicate or plastic material. The lens yields maximum light emission efficiency when a planar SSL center beam is in proximity to the perpendicular axis of the light source retaining surface, wherein the SSL light source center beam is aimed at the area to be illuminated.

Conversely, the further the central beam angle drifts away from the perpendicular axis of the light source, the greater are the light efficiency losses. Therefore, it is understood that to obtain controlled pattern illumination, maximum illumination area coverage and good uniformity while consuming minimal power, a light emitting device requires efficient and pattern-controlled optics.

The present state of the art for roadway and area lighting locates the light emitting source at the bottom surface of the device. By so doing the light emission losses are significant, necessitating a novel approach for light emitting device architecture and a means for efficient and precise light dispersion.

### SUMMARY

An aspect of the present disclosure recognizes a fixed relation between a light emitting device and an illuminated plane the device is tasked with illuminating. This fixed relation is defined by the light source mounting height, the area to be illuminated, the shape of the area, the location of the area in relation to the mounted height, the target light levels and the uniformity ratio required. Given that these parameters are predictable, using the state of the art optical, mechanical and thermal management design tools, embodiments within the present disclosure can configure the form of the light emitting heat dissipating structure with its coupled light sources to optimally illuminate its targeted illuminated plane. The form and size of the light emitting heat dissipating structure varies by at least one of: the light distribution pattern required, the target light levels, and the light source mounting height.

According to another aspect of the present disclosure, a light emitting heat dissipating structure may include a plurality of light source retaining planar surfaces, a number of light sources, and at least one of: a mounting arm and a heat dissipating structure coupling surface configured for coupling with a support surface. The at least one first light source retaining planar surface of the plurality may be disposed in a first plane that is defined substantially horizontal. At least one second upwardly tilted light source retaining planar surface may be disposed in a second plane bisecting the first planar surface. At least one third upwardly tilted light source retaining planar surface may be disposed in a third plane bisecting the first planar surface. The at least one third upwardly tilted light source retaining planar surface orientation may differ by at least 10 degrees from the at least the one second upwardly tilted light source. At least one light source may be coupled to at least two of: the at least one first, the at least one second, and the at least one third light source retaining planar surfaces. A direction of light emitted from the at least two of: the at least one first, the at least one second, and the at least one third light source retaining planar surfaces may differ from each other. In some embodiments, the mounting arm may be configured to couple with at least one of the plurality of the light source retaining planar surfaces.

In some embodiments, at least one of: the at least one first, the at least one second, or the at least one third light source retaining planar surfaces may be configured to illuminate a short sub-field of illumination and another of the at least one first, the at least one second, or the at least one third surfaces light source retaining planar surfaces may be configured to illuminate a distal sub-field of illumination. In some embodiments, the light emitting heat dissipating structure may include a lens including at least two optical lenses configured to direct light at different sub-areas.

In some embodiments, at least one of: the size, the form, the number of light sources, light source power input, light output of the light sources, light source color temperature, light source color rendition index, orientation and/or tilt angle/s of one of the light source retaining surfaces may be configured in relation to a corresponding sub-field of illumination. The light emitted by at least one pair of light sources with dedicated lenses above coupled to the at least one light source retaining planar surface may be substantially directed toward at least one of: contiguous and non-contiguous sub-areas of a corresponding sub-field.

In some embodiments, at least one pair of light sources with dedicated lenses above may be coupled to at least one of: first, second, and third light source retaining planar surfaces to direct light toward different sub-areas of illumination within their corresponding sub-fields. At least one other light source retaining planar surface may not retain a light source. In some embodiments, the heat dissipating structure may include at least one of: electronic device enclosure, a mounting arm, and a heat dissipating structure mounting surface.

According to another aspect of the present disclosure, a light emitting heat dissipating structure may include light source retaining surfaces, light sources, optical lenses, wherein the light sources are coupled with the retaining surfaces defining a field of illumination comprising sub-fields of illumination including sub-areas of illumination. The first light source retaining surface may be substantially parallel to one of the sub-fields defined as a short sub-field of illumination. At least one second light source retaining surface may bisect the first light source retaining surface. The at least one of second light source retaining surfaces may have an orientation and/or tilt angle different from third light source retaining surface. At least two light sources may be coupled to each of the first light source retaining surface and to at least one of the second and third light source retaining surfaces. At least two optical lenses may be disposed above each of the light sources. The light emitted from the first light source retaining surface may illuminate a substantially different sub-area of illumination than the light emitted from at least one of the second and third light source retaining surfaces.

In some embodiments, a unitarily formed lens may comprise at least two optical lenses configured to direct light at different sub-areas. Different light sources type and/or quantity may be coupled to at least two light source retaining surfaces. At least one light source retaining surface may not retain a light source.

In some embodiments, a cover may be coupled to the heat dissipating structure. A photovoltaic panel cover may be coupled to the heat dissipating structure. The heat dissipating structure may be unitarily formed with at least one of: electronic device enclosure, a mounting arm, and a heat dissipating structure mounting surface.

Accordingly to another aspect of the present disclosure, a light emitting heat dissipating structure may include light source retaining surfaces, light sources, an electronic device enclosure, and a mounting arm or a heat dissipating structure mounting surface. The light source retaining surfaces may include at least one first light source retaining surface disposed substantially horizontal. The light source retaining surfaces may include at least one second light upwardly tilted light source retaining planar surface coupled with the at least one first light source retaining surface. The light source retaining surfaces may include at least one third upwardly tilted light source retaining surface, at least in part, coupled with the at least one first light source retaining surface. The at least one third light source retaining planar surface may have an orientation that differs by at least 10 degrees from the at least the one second upwardly tilted light source. At least one light source may be coupled to at least two of the at least one first, at least one second, and at least one third light source retaining planar surfaces. An electronic device enclosure may be unitary formed with at least one of the plurality of the light source retaining surfaces. The electronic device may be substantially aligned with the mounting arm.

In some embodiments, at least one of: a mounting structure and a cover may be coupled to the heat dissipating structure. A J-box may be incorporated to the mounting arm. The mounting arm may be unitarily formed with at least one heat dissipating fin.

In some embodiments, the heat dissipating structure with the coupled light sources may be configured to be directing its light toward at least one of: horizontal and vertical surfaces.

According to another aspect of the present disclosure, a light emitting heat dissipating structure can to some degree be configured to emulate in the size of a traditional luminaire appearance. However, the exterior appearance within the present disclosure is shaped by associating light sources 21 with pre-configured sub-field of illumination 44. As a result, the exterior surfaces of the heat dissipating structure 1 retaining the light sources 21 define the light emitting heat dissipating structure 1 embodiment's form.

Rapid heat dissipation may be important for sustaining the operational longevity of SSL light source 21. The light emitting heat dissipating structure of present disclosure may be configured to dissipate the heat generated by the light source 21 at least in part through the light source retaining surfaces 5 forming exterior surfaces of the heat dissipating structure 1. These tilt and orientation angles of the surfaces 5 may be configured to aim the coupled light sources 21 in the direction of their designated sub-fields of illumination 44.

At least two light sources 21 include dedicated optical lenses 45 disposed above coupled to a light source retaining module 68 that is coupled to a light source retaining surface 5 may aim their light toward at least two different sub-areas 46 within the same sub-field of illumination 44. The light emitted by the two light sources 21 is controlled by the dedicated optical lenses 45 disposed above the light sources 21. A center beam of the light source 21 may be configured to be aimed at different locations within the sub-field 44. The light sources 21 may then be arranged to have a portion of their light overlap.

Together the sub-areas 46 of illumination may form an evenly lit sub-field of illumination 44, and a portion of the light emitted by the sub-field of illumination 44 may overlap another neighboring sub-field of illumination 44 to form a larger and uniformly lit field of illumination 43. The field shape may be configured as needed.

In some embodiments, the light emitting heat dissipating structure may include an electromechanical arrangement geared toward incorporating at least one photovoltaic power generating device to a pole 60 mounted luminaire to self-power at least one electronic device 26 coupled to and/or controlled by the heat dissipating structure 1.

According to another aspect of the present disclosure, a light emitting heat dissipating structure includes light source retaining surfaces, light sources, and an arm. At least one light source retaining planar surface may be disposed substantially parallel to the longitudinal axis of an arm coupled to support structure. At least one light source retaining planar surface may be disposed substantially perpendicularly to the longitudinal axis of an arm coupled to support structure. At least one light source retaining planar surface may be disposed substantially vertically to the longitudinal axis of an arm coupled to support structure, and at least two light sources may be coupled to at least the plurality of the light source retaining surfaces.

According to another aspect of the present disclosure, a light emitting heat dissipating structure includes light source retaining surfaces, light sources, and a heat dissipating structure coupling surface. The heat dissipating coupling surface couples to at least one of: a vertical and a horizontal support structure. The coupling surface may be unitary formed with the heat dissipating structure having an exterior surface adapted to couple to the support structure.

In some embodiments, the at least one light source retaining surface may be configured to illuminate a short sub-field of illumination, and at least one other light source retaining surface may be configured to illuminate a distal sub-field of illumination. The light emitting heat dissipating structure of the present disclosure may include a unitarily formed lens that comprises at least two optical lenses configured to direct light at different sub-areas. In some embodiments, at least one of: the size, the form, the number of light sources, light output of the light sources, orientation and/or tilt angle/s of the light source retaining surface may be configured in relation to at least one of: the distal and direction of the light source retaining surface to a corresponding sub-field of illumination.

In some embodiments, the light emitted by at least one pair of light sources with dedicated lenses above may be coupled to a light source retaining surface substantially parallel to the longitudinal axis of the support arm may be directed at different sub-areas of a corresponding sub-field. At least one pair of light sources with dedicated lenses above may be coupled to at least one of: the light source retaining surface of the perpendicularly and the vertically disposed surfaces to the longitudinal axis of the support arm direct light toward different sub-areas of illumination within their corresponding sub-fields and the retaining surface corresponding to the parallel planar surface to the longitudinal axis of the supporting arm. At least one light source retaining surface may not retain a light source.

According to another aspect of the present disclosure, a light emitting heat dissipating structure includes light source retaining surfaces, light sources, optical lenses; a field of illumination, sub-fields of illuminations and sub-areas of illumination. The first light source retaining surface may be substantially parallel to a short field of illumination. At least one second light source retaining planar surface may bisect the first light source planar surface. At least one of the second light source retaining surfaces' orientation and/or tilt angle may be different from another second light source retaining surface orientation and/or tilt angle. At least two light sources may be coupled to the first and at least one of the second light source retaining surfaces. At least two optical lenses may be disposed above the two light sources coupled to the first and the at least second light source retaining surfaces. The light emitted from the first light source retaining surface may substantially illuminate a different sub-field of illumination than the light emitted from the at least second light source retaining surface.

In some embodiments, a unitarily formed lens may include at least two optical lenses configured to direct light at different sub-areas. The mix of light sources and quantity coupled to at least two light source retaining surfaces may be different. At least one light source retaining surface may not retain a light source. The light emitting heat dissipating structure of the present disclosure may include a cover coupled to the heat dissipating structure.

In some embodiments, a photovoltaic panel cover may be coupled to the heat dissipating structure. The heat dissipating structure may be unitarily formed with at least one of: electronic device enclosure, a mounting arm and heat dissipating structure coupling surface. At least one pair of light sources with dedicated lenses coupled to the first and at least one second light source retaining surface may direct their light toward different sub-areas within their respective sub-fields of illumination.

In some embodiments, at least one light source coupled to at least one light source retaining surface is receives input from at least one of: a processor, a sensing device, and a communication device. At least one of: a processor, a sensing device, and a communication device are coupled to at least one of: the heat dissipating structure, the support structure, and a location in the vicinity of the heat dissipating structure.

In some embodiments at least one non-power grid dependent power generating device at least in part energizes at least one electronic device coupled to the heat dissipating structure. Such power generating device may include at least one of: photovoltaic panels and wind turbine.

According to still another aspect of the present disclosure, a light emitting heat dissipating structure includes light source retaining surfaces, light sources, and an electronic device enclosure. At least one light source retaining planar surface may be disposed on a surface substantially parallel to the horizontal axis of the light emitting heat dissipating structure. At least one light retaining planar surface may be substantially perpendicularly disposed to the light source retaining surface that may be substantially parallel to the horizontal axis of the heat dissipating structure. At least one light retaining planar surface may be substantially parallel and vertically tilted in relation to the horizontal light source retaining planar surface that may be substantially parallel to the horizontal axis of the heat dissipating structure. An electronic device enclosure may be at least partially disposed within an embodiment such that when horizontally mounted may be defined by at least one horizontal and two non-parallel vertical surfaces of the light source retaining surfaces.

In yet another aspect of the present disclosure, at least one of: an arm and a cover may be coupled to the heat dissipating structure. A junction box may be incorporated into the arm. The arm may be unitarily formed with the heat dissipating structure. The heat dissipating structure may be configured to be directing its light toward at least one of: horizontal and vertical surfaces.

According to another aspect of the present disclosure, a method of forming a light emitting heat dissipating structure may include providing a light emitting heat dissipating structure including a plurality of light source retaining planar surfaces of different tilt and orientation angles, a number of light sources, a number of lenses disposed above the light sources aiming the light at different directions, and a mounting surface configured for coupling with support structure, and defining a fixed relation between one of the plurality of light source retaining planar surfaces and an illumination target for illumination. The fixed relation may be defined according to at least one of a light source mounting height, an area of the illumination target to be illuminated, a shape of the area, a location of the area in relation to the mounted height, a target light level, and a required uniformity ratio.

### BRIEF DESCRIPTION OF THE DRAWINGS

FIG. 1A shows the pattern of light emission by a pole mounted roadway heat dissipating structure;

FIG. 1B shows the bottom face of a heat dissipating structure with arrows indicating the general beam direction of the plurality of the coupled light sources coupled;

FIG. 2A shows the top view of a roadway heat dissipating structure with electronic device enclosure cover removed;

FIG. 2B shows the bottom face of the roadway heat dissipating structure;

FIG. 3A shows a longitudinal section of a roadway heat dissipating structure;

FIG. 3B shows a transverse section of a roadway heat dissipating structure;

FIGS. 4A, 4B, 4C and 4D show pole mounting configurations for the heat dissipating structure/s;

FIGS. 4E, 4F and 4G show pole mounting configurations for the heat dissipating structure/s coupled to photovoltaic top cover;

FIGS. 5A, 5B, 5C and 5D show top view, bottom view, side view and a section of an area illuminating assembly of the heat dissipating structure coupled to a pole; and

FIGS. 6A and 6B show top and bottom perspectives of an area illuminating heat dissipating structures assembly coupled to a pole and top coupled photovoltaic panel.

### DETAILED DESCRIPTION

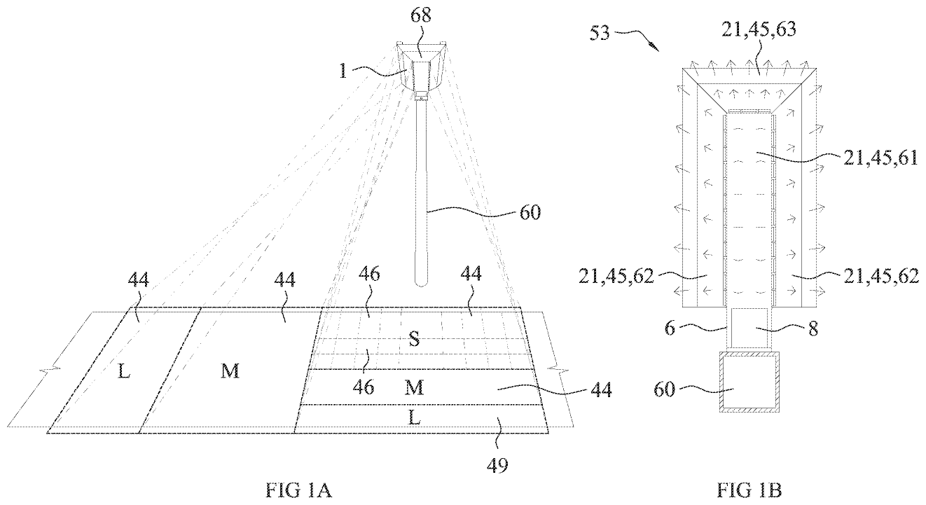

FIG. 1A shows a roadway and an adjacent pole 60. On the pole 60, a heat dissipating structure (HDS) 1 with coupled light emitting modules illuminate at least the roadway below. The light source 21 illustratively includes light source retaining modules 68 coupled to the light source retaining surfaces 5 of the heat dissipating structure 1. At least one of the light sources retaining surfaces 5 is tilted and/or oriented to emit the light from a coupled light source 21 toward a pre-configured sub-field of illumination 44. Dedicated optical lenses 45 may be disposed over the light sources 21 and may direct the emitted light toward pre-configured sub-areas of illumination 46 within a field of illumination 43.

FIG. 1A shows the heat dissipating structure 1 having seven light source retaining surfaces 5. Five of the seven surfaces 5 display their light dispersion pattern. Three of the surfaces 5 are at the bottom and the front of the heat dissipating structure 1. Of the three surfaces 5, one is substantially horizontal, and the two others are tilted vertically. Since the distance between the roadway and the heat dissipating structure 1 directly above is the shortest, the light source 21 output and/or the light source retaining surface/s area/s corresponding can be reduced.

FIG. 1A shows the sub-field of illumination 44 directly below the heat dissipating structure 1 dividing the light emission range zones into “S” 47 (short), “M” 48 (medium) and “L” 49 (long). The field of illumination 43 can be divided into a plurality of sub-fields of illumination 44. The sub-fields of illumination 44 can be further divided into illumination zones that can be further gridded into sub-areas of illumination 46. At least two light sources 21 with the optical lenses 45 disposed above and coupled to the same sub-field 44 dedicated light source retaining surface 5, can direct their emitted light to different sub-areas of illumination 46 within the sub-field of illumination 44 zones. FIG. 1A shows an example of zone “S” 47 of the sub-field of illumination 44 gridded by sub-areas 46. The arrangement of the plurality of light sources 21 coupled to their corresponding dedicated optical lenses 45 is configured in relation to the sub-areas 46 of the gridded zone within a sub-field of illumination 44. Such an arrangement can include preconfiguring the light source 21 and its corresponding lens 45: output, light dispersion angles, and directionality. A portion of the light emitted by at least two light sources 21 with corresponding lenses 45 and directed to at least two different sub-areas 46 can be configured to overlap, wherein the contribution from the at least the two light sources 21 improve the uniformity ratio of the aggregate area of the two sub-areas 44.

Of the nine light source retaining surfaces 5 shown in the figure, two vertically tilted surfaces 5 are shown on each side of the heat dissipating structure 1. FIG. 1A shows the light emission pattern of only a portion (2 faces) of the light emitting heat dissipating structure 1. The light emission patterns are similar to the arrangement of the sub-field 44 range zones directly below the heat dissipating structure 1 and show two sub-fields 44 corresponding to the medium range “M” 48 and the long-range “L” 49 coverage zones. Also, as with the other sub-field illumination 44 coverage logic, this sub-field of illumination and the sub-field at the opposite side illumination sub-areas can be gridded with light of individual light sources 21 directed to different sub-areas 46.

Finally, the arrangement of all the light source retaining surfaces 5 with their respective coupled light sources 21 and corresponding dedicated optical lenses 45 is configured to uniformly merge the light intensity between each of the sub-areas 46, sub-field of illumination 44 and adjacent sub-field/s of illumination 44 to form a uniformly illuminated field of illumination 43.

FIG. 1B shows the bottom view of a roadway heat dissipating structure 1. Light sources 21 with the dedicated optical lenses 45 disposed above coupled to the plurality of the light source retaining surfaces 5 of the heat dissipating structure 1 direct their light down, forward and sideways. The totality of the light emitted forms a uniformly illuminated roadway that is consistent with the road's width, maximizing the spacing between the heat dissipating structures 1 mounted on the poles 60.

Arrows drawn on the light source retaining surfaces 21 designate the general direction in which the plurality of coupled light sources 21 with their corresponding dedicated optical lenses 45 aim the light. Chevrons without directional leaders designate the light being aimed downwardly. By contrast to conventional roadway and area illumination standards employing types II, III, IV and V lenses 45, embodiments of FIG. 1A should be understood to employ controlled light beam optical lenses 45 forming optics that form the field of illumination 43 by “quilting” a plurality of sub-areas 46 configured to shape the pattern of the illuminated field as required. Direction of the illustrative arrows of the light source 21 corresponds to at least one of the light source retaining surface 5 tilt angle (e.g., pitch angle) and/or orientation angle (e.g., yaw angle). To attain optimal illumination, energy efficiency, lighting uniformity and maximum area coverage, a number of the light source retaining surfaces 5 of the heat dissipating structure 1 may be increased.

FIG. 1B shows the heat dissipating structure 1 coupled to a pole 60 with an arm 6. A junction box 8 shown incorporated into an arm 6 can provide easy access to electrically and/or mechanically coupling the heat dissipating structure 1 to a pole 60.

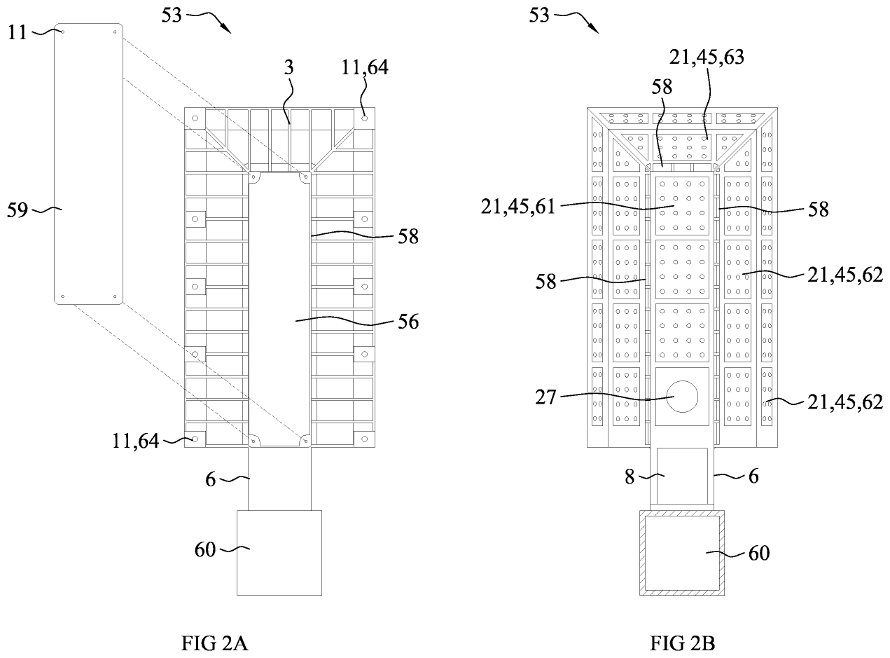

FIG. 2A shows the top view of a roadway heat dissipating structure 1 coupled to a pole 60. The electronic device enclosure cover 59 of the heat dissipating structure 1 is illustrated in a removed position. Electronic devices 26 including at least one of: a communication device 33, a processing device 17, a power storage device 23, a sensing device 18, 27, 32, and other output devices can be placed inside an electronic device enclosure 56. Other exterior coupled devices and/or remote devices can be electrically and/or communicatively coupled to devices inside the electronic device enclosure 56. Power enters the electronic device enclosure 56 from the pole 60 through an arm 6. The heat dissipating structure 1 and the arm 6 can be fabricated of metallic or non-metallic material. Along the perimeter of the electronic device enclosure 56 cool air is induced from below to rise and flow through the openings 58, cooling the light source retaining surfaces 5 and heat generated by devices retained inside the electronic device enclosure 56.

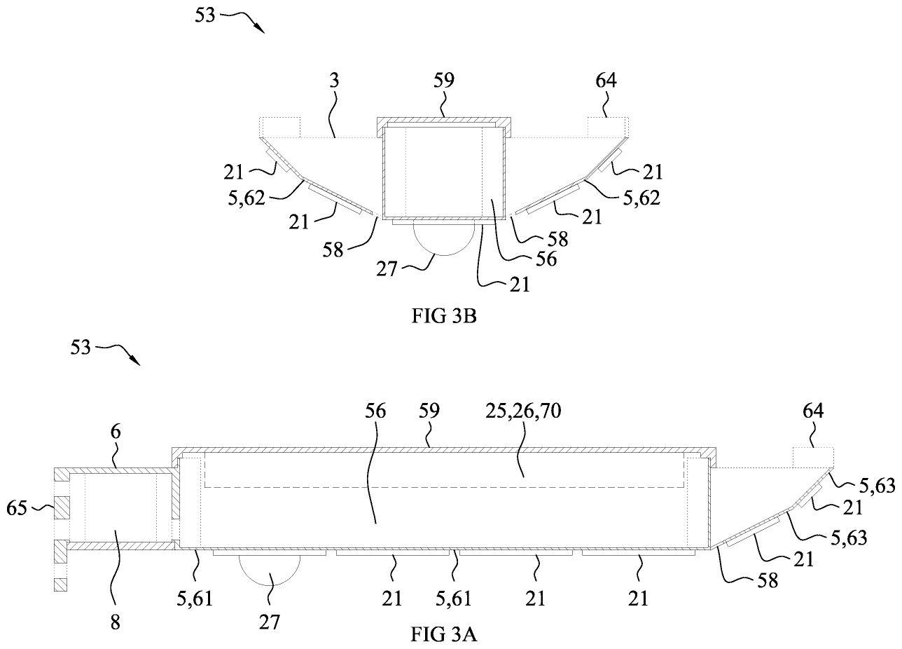

A plurality of heat dissipating fins 3 disposed perpendicularly to the electronic device enclosure 56 and coupled to both the back side of the light source retaining surfaces 5 and the electronic device enclosure 56 dissipate heat generated by the light source 21 and the electronic device/s 26 of the electronic device enclosure 56. The fins 3 also provide structural rigidity to the heat dissipating structure 1 by acting as stiffeners. When a cover 67 is placed on top of the heat dissipating structure 1, the cool air entering the heat dissipating structure 1 from below is compartmentalized by the fins 3 and is redirected to the exterior perimeters of the heat dissipating structure 1 removing heat from the fins 3. The heat dissipating structure 1 profile tapers at at least three sides (see FIGS. 3A and 3B). Moisture that enters any of the compartments formed between the fins 3 flows down and exits through the through openings 58.

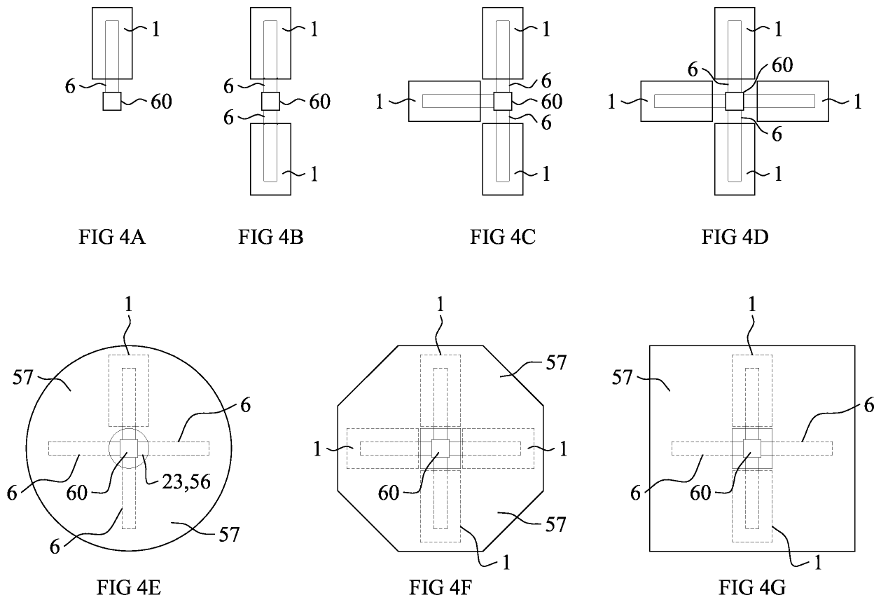

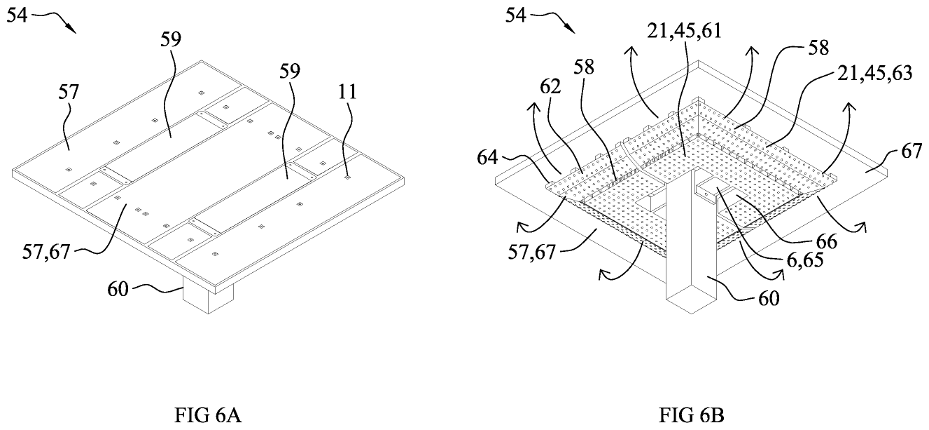

Coupling stands 64 rise above the heat dissipating structure 1 around the top outer perimeter of the heat dissipating structure 1. The coupling stands 64 enable securing the cover 67 to the heat dissipating structure 1 while leaving a venting opening for warm air to exit an interior of the heat dissipating structure 1. The coupling stands 64 can have threaded bores 11 to mechanically secure fastening devices 14 from above or employ other fastening methods to secure a cover 67 to the heat dissipating structure 1. Size and form of the cover 67 may be the same as, or may correspond to, the exterior outline of the heat dissipating structure 1 or can extend outward beyond perimeter of the heat dissipating structure 1. The coupling stands 64 may be used to secure a shielding device cutting off any stray light. FIGS. 4 and 6 also show using the photovoltaic panels 57 on top of the heat dissipating structure 1. The photovoltaic panels 57 can also be secured to the heat dissipating structure 1 by the coupling stand 64.

FIG. 2B shows the bottom view of a roadway heat dissipating structure 1 coupled to a pole 60. The roadway heat dissipating structure 1 is coupled to a pole 60 by an arm 6. As illustrated in FIG. 2B, the junction box 8 may be incorporated into the arm 6. The arm 6 can be an extension of the electronic device enclosure 56 located within the longitudinal axis of the heat dissipating structure 1. Power and/or data conveyed through the pole 60 access the electronic device enclosure 56 through the arm 6.

Exterior surfaces of the heat dissipating structure 1 comprise a plurality of light source retaining surfaces 5. FIG. 2B shows three such surfaces 5 disposed below the electronic device enclosure 56 retaining light source modules 68 and another surface retaining a camera 27. The latter surface can retain other devices including a light source 21. The retaining surface/s 5 may retain the light sources 21 and the camera 27, may be substantially flat, and may be disposed parallel to the surface illuminated by the light sources 21 coupled thereto.

Through air openings 58 shown around the perimeter of the surfaces 5 that retain the light sources 21 and a camera 27 induce cool air from below to pass through the opening 58 and expel warm air generated by the light sources 21 of the heat dissipating structure and devices disposed inside and/or outside the electronic device enclosure 56. The through air openings 58 also expel fluid that can enter through the air venting openings between the coupling stands 64 above.

Vertically sloping light source retaining surfaces 5 arranged around the through air openings 58 extending upwardly from three sides retain light sources 21. One or more of the size, the form, the number of light sources, light source power input, light output of the light sources, light source color temperature, light source color rendition index, orientation and/or tilt angle/s provided by one or more of the light source retaining surfaces 5 is configured in accordance with the illumination demands placed on the light source 21 with respect to illuminating a specific sub-field of illumination 44. Above at least two of the dedicated optical lenses 45 of the light sources 21 direct the emitted light toward at least two specific sub-areas 46 within a zone of a sub-field of illumination 44.

FIG. 2B shows the light sources 21 at the front of the roadway heat dissipating structure 1 disposed perpendicularly to the light sources 21 disposed along the sides of the heat dissipating structure 1. This arrangement is compatible with illuminating an elongated light source retaining surface 5 that is disposed perpendicularly to the longitudinal axis of the heat dissipating structure 1. In this configuration, the light source retaining surface 5 area of the light sources 21 disposed along the sides of the heat dissipating structure 1 are greater than in the front, as more light sources 21 are needed to illuminate the elongated distal area of the roadway. However, the heat dissipating structure 1 light source retaining surfaces' 5 arrangement configures for area illumination may employ equal size surfaces 5 for the front and sides of the heat dissipating structure 1.

The geometry of the light source retaining surfaces 5 of the heat dissipating structure 1 can take any form needed to meet the illumination performance required of the light source's 21 coupled to the light source retaining surface/s 5. Further, size of the heat dissipating structure 1 may be scalable, and the heat dissipating structure 1 may be unitarily fabricated of metallic or non-metallic material.

FIG. 3A shows a longitudinal section of a roadway heat dissipating structure 1. On top, an electronic device enclosure cover 59 is shown covering the electronic device enclosure 56. Inside the electronic device enclosure 56, electronic devices 26 can be coupled to the floor of the enclosure 56, side walls and/or the bottom side of the electronic device cover 59. Power and/or data access the electronic device enclosure 56 through a coupled arm 6 and/or the heat dissipating coupling surface 69 (not shown). The light emitting heat dissipating structure may be attached to any vertical or horizontal support structure.

The bottom surface of the electronic device enclosure 56 can be the light retaining surface/s of the light sources 21 disposed parallel to a distal illuminated surface. FIG. 3A shows three light source retaining modules 68 and the camera 27 coupled to these surfaces.

At the front of the heat dissipating structure 1, two vertically sloped light source retaining surfaces 5 extend upwardly and outwardly from the electronic device enclosure 56. Each of the surfaces is shown coupled to a light source module 68. Vertical fins 3 arranged in parallel to the longitudinal axis of the heat dissipating structure 1 couple the vertically sloped surfaces to the electronic device enclosure 56. Through air openings 58 at the bottom of the sloped surfaces by the electronic device enclosure 56 induce flow of cool air from below to remove heat generated by the electronic devices 26 of the heat dissipating structure 1. These opening also remove moisture that enters from above.

Coupling stands 64 shown extending upwardly from the top of the vertically sloped light source retaining surfaces 5 enable coupling a cover to the heat dissipating structure 1 from above (not shown). The coupling stand 64 typically has the threaded bore 11. The cover 67 is secured to the coupling stand 64 with a through threaded fastening device 14.

FIG. 3B shows a transverse section of a roadway heat dissipating structure 1. At the center of the figure the electronic device enclosure 56 is shown with the electronic device enclosure cover 59 on top.

Heat dissipating fins 3 shown on both sides extend from the walls of the electronic device enclosure 56 outwardly coupling the vertically sloped light source retaining surfaces 5. The fins 3 dissipate heat generated by the electronic device/s 26 of the heat dissipating structure 1 while providing structural rigidity to the structure.

Light source retaining modules 68 may be coupled to the light source retaining surfaces 5 at bottom surfaces of the vertically sloped light source retaining surfaces 5 and the bottom of the electronic device enclosure 56. The camera 27 may be coupled below the electronic device enclosure 56. That surface can retain at least one of: a sensing device 18, 31, 32, a communication device 33, a processing device 17, and any Internet of Things (TOT) input/output device, such as an TOT sensing device 39.

Coupling stands 64 shown extending upwardly from the top of the vertically sloped light source retaining surfaces 5 at both sides of the heat dissipating structure 1. These stands 64 enable coupling the cover 67 to the heat dissipating structure 1 from above (not shown). The coupling stand 64 typically has the threaded bore 11 corresponding to the bore 11 in the cover 67. At least one fastening device 12, 14 couples the cover 67 to the heat dissipating structure 1. Through air openings 58 shown at the bottom of the sloped light source retaining surfaces 5 by the electronic device enclosure 56 induce flow of cool air from below to remove heat generated by the electronic devices 26 of the heat dissipating structure 1. These opening 58 also remove moisture that enters from above.

FIGS. 4A, 4B, 4C and 4D show pole 60 mounting configurations for roadway heat dissipating structure/s 1. FIG. 4A shows a single heat dissipating structure 1 coupled to a pole 60. FIG. 4B shows two heat dissipating structures 1 coupled in a back-to-back manner to a pole 60. FIG. 4C shows a (tri) configuration of three heat dissipating structures 1 disposed at 90° to one another. FIG. 4D shows a (quad) configuration of four heat dissipating structures 1 disposed at 90° to one another. The elements shown in FIGS. 4A, 4B, 4C, and 4D include the heat dissipating structure 1, the arm 6, and a pole 60.

Example configurations of several heat dissipating structures 1 include orthogonal mounting arrangements. As another example, the heat dissipating structure 1 can have other mounting configurations that are non-orthogonal. Also, by extending the arms 6, more heat dissipating structures 1 may be coupled to a pole 60. The pole 60 can have a square, round, segmented or non-volumetric profile, such as an I-beam profile. The heat dissipating structure 1 having shallow profile can minimize wind load stress on the pole 60. As a result, smaller diameter poles 60 and/or poles 60 of a thinner wall thickness may be needed to support the heat dissipating structure 1.

FIGS. 4E, 4F and 4G show pole 60 mounting configurations for the heat dissipating structure/s 1 coupled to the photovoltaic panel 57 used as the cover 67. The cover 67 may be configured to cover the area within the exterior perimeter of the heat dissipating structure 1 or extend outwardly overhanging beyond. The three figures show examples of the covers 67 of heat dissipating structure 1 that extend beyond, e.g., overhang, the heat dissipating structure 1. The covers show different geometric forms supported by a heat dissipating structure 1 below and/or by an extended arm 6. The covers 67 shown may include one more photovoltaic panels 57. FIGS. 6A and 6B show in more detail a pole 60, heat dissipating structure 1, and the photovoltaic panel 57. Coupling stands 64 disposed on the heat dissipating structure 1 and/or the extended arm/s 6 provide a means to mechanically secure the panel 57 to the heat dissipating structure 1 using a fastening device 12, 14.

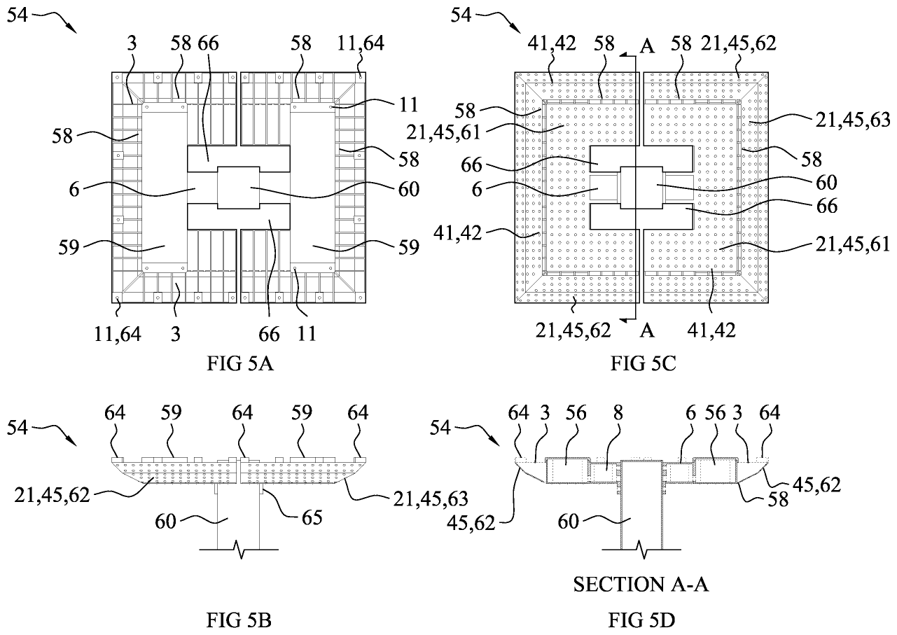

FIGS. 5A, 5B, 5C, and 5D show top view, bottom view, side view and a section of an area illuminating heat dissipating structure 1 coupled to a pole 60.

FIG. 5A shows a top view of an assembly consisting of two area illuminating heat dissipating structure's 1 coupled to a pole 60. The view does not show an optional cover 67 of the heat dissipating structure 1. The elements of each of the heat dissipating structures 1 include: an electronic device enclosure cover 59, the threaded bores 11 securing the electronic device enclosure cover 59 to the enclosure 56, through air openings 58 allowing for cool air rising from below to cool the electronic devices 26 of the heat dissipating structure 1, a plurality of coupling stands 64 disposed around the outer perimeter of the heat dissipating structure 1, a plurality of heat dissipating fins 3, the arm 6 coupled to the pole 60, and a central through opening 66. The electronic devices 26 of the heat dissipating structure 1 generate heat. Cooler air is induced to rise and enter the central through opening 66 by air pressure differential between the top and bottom of the heat dissipating structure 1. The through air openings 58 disposed below and around the exterior perimeter of the electronic device enclosure 56 coupled with the central through opening 66 disposed between the heat dissipating structure 1 and a pole 60 reduce the temperature of the heat dissipating structure 1. As a result, more power can be driven to the electronic devices 26 of the heat dissipating structure 1 and/or the form of the heat dissipating structure 1 can be reduced, i.e., made smaller.

The assembly form can take several geometric shapes. FIG. 5A shows an equilateral square shape form configured to emit type V square patterned illumination.

FIG. 5B shows a partial elevation of an assembly consisting of two area illuminating heat dissipating structures 1 coupled to a pole 60. The view does not show an optional cover 67 of the heat dissipating structure 1. The elements shown include two heat dissipating structures coupled to a pole 60. The mounting bracket 65 extending horizontally or vertically from a support structure in this embodiment is unitary coupled to the arm 6 of the heat dissipating structure 1 and is shown below the heat dissipating structure 1. In some embodiments the bracket is an intermediate mechanical or electromechanical device coupling the heat dissipating structure 1 to a support structure (Not shown). Above, coupling stands 64 and electronic device enclosure covers 59 are shown extending upwardly from a top of each of the heat dissipating structures 1. The elevation of the heat dissipating structure 1 below is populated with light sources 21, with the dedicated optical lenses 45 disposed above coupled to light source 21 retaining surfaces of the front light source retaining surfaces 63 and the sides light source retaining surfaces 62.

FIG. 5B shows two light source retaining surfaces 62, 63 with each heat dissipating structure 1. The side surface 62 is shown in frontal view. The surface sides corresponding to the front of the heat dissipating structure 1 are shown in profile 63.

FIG. 5C shows a heat dissipating structure 1 assembly view from below. An example assembly according to the present disclosure includes the heat dissipating structure 1 with the arms 6 coupled to a pole 60. The elements shown include: a heat dissipating through air opening 58 disposed around the exterior perimeter of the electronic device enclosure 56 and a central through opening 66 located between the heat dissipating structure 1 and a pole 60, and light source retaining surface/s 5 disposed substantially parallel to a corresponding sub-field of illumination 44. Coupled to this surface/s, is/are at least two light sources 21 with at least two dedicated optical lenses 45 disposed above. The light sources 21 coupled to light source retaining surface/s 5 is/are tasked with illuminating the area directly below and in front of the heat dissipating structure 1. This sub-field of illumination 44 is designated “S” 47 for the short distance between the heat dissipating structure 1 and the sub-field 44. The light source retaining surfaces 5 extending outwardly from the exterior perimeters of the surface/s illumination of the “S” 47 sub-field, illuminate medium range “M” 48 and long range “L” 49 sub-fields of illumination 44.

As with the short-range sub-field “S” 47, coupled to each of the “M” 48 and “L” 49 surface/s are at least two light sources 21 with at least two lenses 45 disposed above. At least one of the surface/s' 48, 49 tilt angle and/or orientation is/are configured to also be coupled with at least two light sources 21, each light source 21 being covered by the dedicated optical lens 45, wherein at least one surface illuminates at least one pre-configured and designated sub-field of illumination 44. Further, the coupled light sources 21, with their dedicated optical lenses 45 aim at different sub-areas 46 within the specific field of illumination 44. For this reason, the vertical angle of the light source retaining surfaces 5 varies, wherein the surface tasked with illumination the long range “L” 49 sub-field of illumination 44 is the top surface displaying the widest angle, and wherein the 0 angle is the angle perpendicular to the light source 21 retaining surface/s tasked with illuminating the “S” 47 sub-field of illumination 44.

FIG. 5D shows a partial vertical section through an assembly comprising two heat dissipating structures 1 with the arms 6 coupled to the pole 60. Elements shown include the electronic device enclosure 56, fins 3, through openings 58, J-box 8, coupling stands 64, and the front light source retaining surfaces 62 of the heat dissipating structure 1.

FIGS. 6A and 6B show top and bottom perspectives of an area illuminating heat dissipating structure 1 assembly coupled to a pole 60 with the photovoltaic panel 57 coupled on top.

FIG. 6A shows a top perspective of the heat dissipating structure 1 including the photovoltaic panel 57 as a cover. A top surface of the panel 57 converts photonic energy of the sun to electricity. The panel 57 comprises at least one surface. FIG. 6A shows several photovoltaic surfaces that can include the electronic device enclosure cover. The photovoltaic panel 57 used as the cover 67 may be secured to the mounting stands 64 of the heat dissipating structure 1 by the fastening device 12, 14 (which may be formed as a mechanical fastening device) inserted through the threaded bores 11 from the top. The threaded bores 11 are formed in the photovoltaic panel 57 used as the cover 67 and the electronic device enclosure cover 59. In some instances, power storage devices 19, 23 may be placed inside the detachable electronic device enclosure 56. In another embodiment, an inverter 19 and/or a battery 23 may be coupled to the pole 60. The photovoltaic panel 57 used as the cover 67 also provides a sharp cutoff angle for stray light and provides daytime cool air circulation from below, helping to prolong the life of the electronic devices 26 of the heat dissipating structure 1. The present example shows a static photovoltaic panel 57. In some embodiments, at least one portion of the photovoltaic panel can track the sun path throughout at least a portion of the day. The dynamic tracking may include at least one of: a portion of the photovoltaic panel 57 and at least one heat dissipating structure 1. In some embodiments, at least a portion of the photovoltaic panel 57 has an incline corresponding to best geographical altitude the photovoltaic panel 57 is located.

FIG. 6B shows a perspective view of the heat dissipating structure 1 assembly coupled from below to the photovoltaic panel 57 used as a cover. The assembly comprises two heat dissipating structure 1 coupled by the arms 6 with integral pole mounting brackets 65 to a pole 60. A central air opening 66 formed between the pole 60 and the heat dissipating structure 1 coupled to the arm 6 induces cool air from below to enter the space between the top of the heat dissipating structure 1 and the bottom surface of the photovoltaic panel 57 used as the cover 67. The cool air removes warm air formed by at least one of: daytime heat radiated from the photovoltaic panel 57 used as the cover 67 and nighttime heat generated by the electronic device/s 26 of the heat dissipating structure 1. The warm air is vented through openings shown between the mounting/coupling stands 64 disposed around the top perimeter of the heat dissipating structure 1. Also shown are through air apertures 58 disposed around the perimeter of the light source retaining surface/s 5 illuminating the “S” 47 sub-field of illumination 44. Also shown is the central through opening 66 providing additional heat removal capacity, further reducing the thermal stress on the electronic devices 26 of the heat dissipating structure 1. The heat dissipating structure 1 can be configured to employ at least one of: the central through opening 66 and the through air apertures 58 to exhaust warm air formed within and/or above the heat dissipating structure 1.

This figure shows an area lighting heat dissipating structure 1 with light sources 21 symmetrically disposed on all the light source retaining surfaces 5. In another embodiment requiring a different light distribution pattern, a different mix and quantity of light sources 21 can be coupled to any one light source retaining surface 5 and/or no light source 21 is coupled to at least one light source retaining surface 5. Further, a mechanical device acting as a visor can be coupled to the photovoltaic panel 57 used as the cover 67 to control the emitted light directionality (not shown).

The present disclosure includes novel approaches for increasing the light emittance efficiency through the dedicated optical lens 45. Rather than re-directing the emitted light rays of the light source 21 through the dedicated optical lens 45, a light emitting heat dissipating structure of the present disclosure can adapt the orientation and tilt angles of the luminaire's heat dissipating structure 1 light source 21 retaining surfaces' to be positioned near to or perpendicular to center beam of the coupled light sources 21. At least two light sources 21 may be coupled to the same light source 21 retaining surface aim their light through the dedicated optical lenses 45 toward a pre-designated sub-field of illumination 44 below the heat dissipating structure 1. In so doing, the dedicated optical lenses 45 placed above the light sources 21 can transmit the maximum photonic power while incurring minimal transmission losses.

The design of the light source retaining surfaces 5 with the coupled light sources 21 having the dedicated optical lenses 45, are pre-configured to deliver pattern controlled uniform illumination over large areas while consuming a reduced and/or minimal amount of power. The pre-configured design variables include: the shape of the area to be illuminated, the heat dissipating structure 1 mounting height, the size of the area to be illuminated, the light level required, the uniformity ratio required, the light color temperature, and spectral distribution. The heat dissipating structure 1 can be mounted vertically or horizontally so when the heat dissipating structure 1 is coupled to a pole 60, its light source retaining surfaces 5 face the ground below and when tasked with illuminating a vertical surface, its light retaining surfaces face the vertical surface.

The heat dissipating structure 1′ light source retaining surfaces 5 are comprised of at least two bisecting surfaces wherein at least one surface is horizontal or substantially horizontal, while the other surface is not. The exterior form of the heat dissipating structure 1 is derived by arranging the orientation and tilt angle of a plurality of the light retaining surfaces 5 to optimize the efficiency of the photonic power transmitted by the heat dissipating structure′ 1 light sources 21. A higher efficiency heat dissipating structure 1 form employs a multiple of light source retaining surfaces 5. The surfaces may form a plurality of geometrical shapes.

The exterior architecture of the heat dissipating structure 1 is defined by the light source retaining surfaces 5 to which light source modules 68 are coupled. These surfaces face corresponding sub-fields of illumination 44 below. An electronic device enclosure 56 can be disposed within a cavity 4 formed by the light source retaining surfaces 5. When facing the ground, the electronic device enclosure 56 is at least partially disposed inside the heat dissipating structure 1 defined by at least one horizontal and two non-parallel vertical surfaces of the light source retaining surfaces 5.

At least one light source retaining module 68 is coupled to the light source retaining surface 5 wherein a light source retaining module 68 is populated with at least two light sources 21. One or more of the dedicated optical lens 45 may be disposed over each of the plurality of light sources 21.

The illustrative light source's 21 with at least two optical lenses 45 above, coupled to a light source retaining module 68 and retained by a light source retaining surface 5:

1. Are perpendicularly or substantially perpendicularly disposed to the light source retaining surface 5, and

2. Direct the center beam of a first light source 21 toward a preconfigured sub-area 46 of a sub-field of illumination 44, and direct the center beam of a second light source 21 toward a different sub-area 46 of at least the same field of illumination 46, and

3. Can direct the center beams of the first and second light sources 21 toward contiguous sub-areas 44 of the field of illumination 46, and

4. The lenses 45 of the first and second light sources 21 can be unitarily fabricated in a single embodiment, and

5. Are coupled to light source 21 retaining planar surfaces that are nonaligned, bisecting one another, and

6. tilt and/or orientation angle/s coupled to at least one first non-horizontal light source retaining surface 5 is different from the tilt and/or orientation angle/s of the light source's 21 coupled to a second non-horizontal light source retaining surface 5.

Field, Sub-Field, and Sub-Area of Illumination

The light emitting heat dissipating structure of the present disclosure provides illumination light levels and uniformity ratios that may be preconfigured in relation to a field of illumination 43 disposed below or in front of the heat dissipating structure 1. The field is divided into at least two sub-fields 44, wherein each sub-field 44 is divided into a plurality of sub-areas 46. The at least two sub-fields of illumination 44 are comprised of a field designated by the letter “S” 47 (short), and a field designated by the letter “L” 49 (long).

The light emitting heat dissipating structure of the present disclosure provides three sub-fields of illumination dividing the long sub-field 49 into two areas, one medium sub-field of illumination 48 designated by the letter “M” (medium), while reducing the long sub-field of illumination 49 area coverage.

The heat dissipating structure 1 light source retaining surfaces' 5 tilt and orientation angles, size, number of light sources 21, light source 21 output, and type of lens 45 optics is configured in relation to a sub-field of illumination 44 shape, size, light level requirement, uniformity ratios, and light source 21 temperature and CRI. In addition to the variables stated above, the heat dissipating structure′ 1 design accounts for the mounting height of the heat dissipating structure 1 and the distance of each of the sub-fields of illumination 44 are located from the light source 21.

Each of the sub-fields of illumination 44 is further divided into sub-areas 46. The sub-areas 46 are gridded so that the plurality of light sources 21, coupled to a light source retaining surface 5 direct their light toward specific sub-areas 46 within the sub-field 44. The gridded sub-areas' 46 number can correspond to the number of light sources 21 coupled to a sub-field 44 dedicated light source retaining module 68 and/or a light source retaining surface 5.

At least two light sources 21 with two dedicated lens 45 optics disposed above are configured to illuminate sub-areas 46 within the same sub-field of illumination 44. Each of the light sources 21 has a different at least one of: a center beam tilt angle, a center beam orientation angle, an optical light dispersion pattern, and an optical light dispersion beam angle. The arrangement of the dedicated optical lenses 45 over the light sources 21 is configured for minimal cross beam emittance wherein a portion of the light received at contiguous sub-fields 44 overlaps, emitting a lesser light intensity than the intensity directed toward the center of each of the targeted sub-areas 46.

The light emitting heat dissipating structure of the present disclosure provides the heat dissipating structure 1 light source retaining surfaces 5 with coupled light sources 21 tilted and oriented to aim the light toward sub-fields of illumination 44 that are primarily perpendicular and parallel to the heat dissipating structure 1 longitudinal horizontal axis.

The Mechanical Arrangement of Heat Dissipating Structure

The physical form of the heat dissipating structure 1 optimizes the size of the area coverage and improves the illumination uniformity ratios relative to the power consumed by the heat dissipating structure 1 coupled light sources 21.

The heat dissipating structure 1 comprises at least one bottom, back and front surfaces, at least two side surfaces, and at least one top surface with an optional cover 67. The back of the heat dissipating structure 1 can couple to a mounting arm 6. The arm 6 can be unitarily fabricated with the heat dissipating structure 1. The front, side, and bottom exterior light source retaining surfaces 5 of the heat dissipating structure 1 retain the light source retaining modules 68. These light source retaining surfaces' 5 size, form, tilt angle and orientation are configured in relation to at least one of: the light source module 68 coupled light sources 21, the dedicated optical lens 45 disposed above the light source module 68, the heat dissipating structure′ 1 capacity to dissipate heat, the light source 21 mounting height, and the distance the light source 21 is from the area to be illuminated. The light source retaining surface 5 disposed along the front and side of the heat dissipating structure 1 bisects at least one horizontal surface disposed at the bottom of the heat dissipating structure 1. The opposite longitudinal end of the bisecting surface extends outwardly. The tilt angle of any one vertical plane of the light source retaining surface 5 can range between horizontal and vertical angles when the heat dissipating structure 1 faces an illumination sub-field 44 below.

In some embodiments, two outwardly forward extending light source retaining surfaces 5 may be coupled along their longitudinal ends. The top light source retaining surface's 5 tilt angle may be higher than the surface below. In some arrangements the high tilt angle surface with its coupled light sources 21 may illuminate the “L” 49 sub-field of illumination, the surface below with its coupled light sources 21 may illuminate the “M” 48 medium range sub-field, and the horizontal surface with its coupled light sources 21 may illuminate the “S” 47 sub-field generally disposed below and in the vicinity of the light source 21.

The structure formed by the bottom, back, side, and front light source retaining surfaces 5 forms cavities 4. The cavities 4 exemplary embodiment can include an electronic device enclosure 56 and can be surrounded by a plurality of heat dissipating fins 3. The fins 3 help keeping the electronic devices 26 of the heat dissipating structure 1 cool and provide structural strength.

Through air openings 58 disposed along the exterior of the electronic device enclosure 56 bottom induce flow of cool air from below, venting to the exterior warmer air formed above the light source retaining surfaces 5 and the exterior of the electronic device enclosure 56. The air can vent directly to the above when the area above the heat dissipating fin 3 is uncovered. When a cover 67 is disposed over the heat dissipating fin 3, the warm air is dissipated through openings around the perimeter of the heat dissipating structure 1. The openings around the perimeter are formed by coupling stands 64 that rise above the light source retaining surfaces 5. The coupling stands 64 can be unitarily formed with the heat dissipating structure 1. The coupling stands 64 are spaced apart with a cover 67 disposed above directs the warm air to exit the cavity 4 of the heat dissipating structure 1 through the venting openings located between the spaced apart coupling stands 64 disposed at the top perimeter of the heat dissipating structure 1.

The height of the cover heat dissipating structure cover 67 coupled to the coupling stands 64 can be the same height as the electronic housing enclosure cover 59. Both the heat dissipating structure cover 67 and the electronic housing enclosure cover 59 can have threaded bores 11. Mechanical fasteners 14 then secure the cover to the coupling stands 64 and the electronic device enclosure 56. At the bottom of the vertical light source retaining surfaces 5, vent openings drain any moisture present inside the cavity 4 of the heat dissipating structure 1 between the fins 3.

Efficiency of photovoltaic panels 57 is expected to improve significantly in the near future. In one example, the light emitting heat dissipating structure of the present disclosure includes using the photovoltaic panel 57 as the cover 67 over the heat dissipating structure 1. The photovoltaic panel 57 may be coupled to the coupling stands 64, overhanging beyond the top perimeter of the heat dissipating structure 1. Where a single heat dissipating structure 1 light source 21 is used, the arms 6 extending outwardly from the pole 60 can provide structural support to the photovoltaic panel 57 coupled above, also securing the panel from uplift wind loads. The heat dissipating structure 1 can be fabricated of metallic or non-metallic material by at least one of: casting, molding, and 3D printing manufacturing processes. The size of the heat dissipating structure 1 is scalable, and its surface can be painted and/or can undergo a process to chemically and/or electrically bond color and/or surface texture to at least one of the heat dissipating structure 1′ surfaces.

The Light Source Module

The light source retaining module 68 coupled to the heat dissipating structure′ 1 surfaces can display different characteristics between two coupled light sources 21. These different characteristics can be at least one of: color temperature, color rendition index, light source 21 size, light source 21 form, quantity of light sources 21, and light source 21 output. These light sources 21 differing characteristics can be coupled to the same light source retaining module 68 and/or on a single light source retaining surface 5.

Lens Optics

The SSL light source retaining module 68 is populated with at least two light sources 21. Disposed above the at least two light sources 21, a unitarily fabricated lens 45 comprises at least two dedicated optical lenses 45, wherein the placement of the at least two dedicated optical lenses 45 corresponds to positions of the at least two light sources 21 disposed below. The light emitted by the two light sources 21 through these dedicated optical lenses 45 is directed to different sub-areas of illumination 46 within the same sub-field of illumination 44. The sub-areas 46 can be contiguous to one another. The present state of the art in manufacturing the dedicated optical lens 45 enables:

1. Matching the position of an array of light sources 21 coupled to a light source retaining module 68 with lens 45 optics disposed above.

2. Controlling the lens 45 optics beam spread angle.

3. Controlling the direction of the lens 45 center beam.

4. Controlling the distribution of the lenses 45 within the unitarily fabricated lens 45 embodiment, corresponding to the size and location of light sources 21 disposed on the light source retaining module 68.

Fabricating reduced profile optics causing minimal cross optics shadowing.

The lens 45 is made of translucent material, is disposed above at least one of: a light source 21, a light source retaining module 68, and a plurality of light source retaining modules 68. The lens 45 can be formed by at least one of: 3D printing and by laser etching. The unitarily formed lens 45 can be formed having a plurality of micro/nano 40 lenses 45. The micro/nano 40 lenses' 45 profile can be less than 5 mm, substantially reducing transmission losses due to shadowing by neighboring lenses 45. The unitarily formed lens' 45 dimensions and shape can vary, and so can any lens 45 dispose within the unitarily formed lens 45. The lens 45 form's shape and size correspond to the light source 21 output, shape and size disposed below configured to targeted sub-field of illumination 44 at known distance. Precise optical design then configures the lens 45 size, center beam, tilt angle, orientation angle, and the lensed 45 emitted light distribution pattern. The lens 45 can be fabricated to employ a reflective coating that captures and redirect stray light in a desired direction.

Power Supply

As the SSL light source 21 efficiency improves, the demand on the power supply is reduced. Today's common roadside and area lighting luminaires' power demands ranges between 50 W and 500 W. In this decade, the power demand for the same light output performance is expected to be reduced by at least 25%. The power supply 25, 70 can be enclosed inside a weather protected electronic housing enclosure 56 unitarily formed with the heat dissipating structure 1. The power is delivered to the heat dissipating structure 1 power supply 25, 70 through a mounting arm 6. The mounting arm 6 can be unitarily coupled to the heat dissipating structure 1 and can also comprise a J-box 8. Inside the J-box 8, incoming power or/data can be coupled to the power supply 25, 70 and/or data conductors 37. An SSL driver 25 and/or other electronic devices 26 can be disposed inside the electronic housing enclosure 56. Such devices can include IOT sensing devices 39, power generation devices, such as the photovoltaic panel 57 and 19, communication devices 33, processing devices 17, and power storage devices 23. In another embodiment, the power supply 25, 70 can be disposed inside an enclosure protected from the weather that is coupled to a pole 60. Such an enclosure can be located above the hand hole and below the pole 60 cap. In yet another embodiment, a power supply can be disposed on top of the pole 60 inside a protective enclosure. In the latter two examples, the electronic device enclosure 56 of the heat dissipating structure 1 can retain other devices including one of: a power storage device 23, a power generation related device 19, a processor, a communication device 33, a drone docking device, an accelerometer, and sensing devices 18, 27, 32.

IOT Devices

IOT devices can be coupled to at least one of: the heat dissipating structure 1, the pole 60, and areas in the vicinity of the pole 60. The devices can include sensing devices, communication devices 33, power generation/storage devices 19, 23, electrical motor/s, and processing/controlling devices 17. Such devices can operate independently of one another and/or in unison. The devices can also be coupled communicatively 33 with neighboring and remote devices. These devices can be communicatively 33 coupled to fixed devices and mobile devices, and/or mobile devices such as passing vehicles. At least one device can be governed by a processor 17 and can respond to at least one event in real time. The processor 17 can operate on code that employs AI algorithms that have the capacity to learn and improve the heat dissipating structure 1 performance based on at least one of: recorded past events experienced and communicated input. The AI code also can prioritize the operation of the devices it controls locally and communicatively controls remotely. The devices can be coupled to the interior and/or the exterior of the heat dissipating structure 1, the interior and/or exterior of the pole 60, and to other above and below grade locations in the vicinity of the pole 60.

Power Generation and Power Storage

The photovoltaic panels 57, storage batteries 23, and SSL light source 21 technologies have been advancing rapidly. The form factor of these devices is becoming smaller. In this decade, it is conceivable that in geographical locations with year-round sunlight, roadway lighting can be substantially or wholly powered by photovoltaic power. For example, today's photovoltaic panels can generate 5.5 kwh/sqm under Arizona sun. The present heat dissipating structure 1 is configured to couple to the photovoltaic panel 57. The photovoltaic panel 57 is disposed on top of the heat dissipating structure 1 and can extend outwardly overhanging from above, mechanically secured to the heat dissipating structure′ 1 coupling stands 64. The generated power can be stored inside the heat dissipating structure 1 electronic device enclosure 56, an enclosure coupled to the pole 60 or placed on top of the pole 60.

Although certain illustrative embodiments have been described in detail above, variations and modifications exist within the scope and spirit of this disclosure as described and as defined in the following claims.

LIST OF ELEMENTS

| | |
|---|---|
| 1. | Heat dissipating structure (HDS) |
| 2. | Heat sink |
| 3. | Fins |
| 4. | Cavity |
| 5. | Light source retaining surface |
| 6. | Arm |
| 7. | Hinge |
| 8. | Junction box |
| 9. | Enclosure |
| 10. | Access cover/door |
| 11. | Bore |
| 12. | Screw/bolt |
| 13. | Mechanical connector |
| 14. | Mechanical fastener |
| 15. | Retaining/mounting structure |
| 16. | |
| 17. | Processor |
| 18. | Occupancy sensor |
| 19. | Inverter |
| 20. | |
| 21. | Light source |
| 22. | |
| 23. | Battery |
| 24. | Conduit |
| 25. | Driver |
| 26. | Electronic device |
| 27. | Camera |
| 28. | |
| 29. | Indicator |
| 30. | Transceiver |
| 31. | Mic/speaker |
| 32. | Air quality/smoke sensor |
| 33. | Communication device |
| 34. | |
| 35. | |
| 36. | |
| 37. | Conductor |
| 38. | Electrical receptacle |
| 39. | IOT device |
| 40. | Micro or nano optical lens |
| 41. | Micro optics |
| 42. | Nano optics |
| 43. | Field of illumination |
| 44. | Sub-field of illumination |
| 45. | Lens |
| 46. | Sub-area of illumination |
| 47. | “S” short field of illumination |
| 48. | “M” medium field of illumination |
| 49. | “L” long field of illumination |
| 50. | |
| 51. | Optical control device |
| 52. | |
| 53. | Roadway lighting luminaire |
| 54. | Area lighting luminaire |
| 55. | Ambient light luminaire |
| 56. | Electrical device housing/enclosure |
| 57. | Photovoltaic panel |
| 58. | Through air opening/aperture |
| 59. | Electrical device enclosure cover |
| 60. | Pole |
| 61. | Bottom light source retaining surface |
| 62. | Side light source retaining surface |
| 63. | Front light source retaining surface |
| 64. | Coupling stand |
| 65. | Pole mounting bracket |
| 66. | Central through air opening/s |
| 67. | Heat dissipating structure cover |
| 68. | Light source retaining module |
| 69. | HDS coupling surface |
| 70. | Power supply |

1. A light emitting heat dissipating structure comprising:
a plurality of light source retaining planar surfaces, a number of light sources, and a mounting surface configured for coupling with support structure;
wherein at least one first light source retaining planar surface of the plurality is disposed in a first plane that is defined substantially horizontal,
wherein at least one second upwardly tilted light source retaining planar surface is disposed in a second plane bisecting the first planar surface,
wherein at least one third upwardly tilted light source retaining planar surface is disposed in a third plane bisecting the first planar surface,
wherein the at least one third upwardly tilted light source retaining planar surface orientation differs by at least 10 degrees from the at least the one second upwardly tilted light source,
wherein at least one light source is coupled to at least two of: the at least one first, the at least one second, and the at least one third light source retaining planar surfaces,
wherein a direction of light emitted from the at least two of: the at least one first, the at least one second, and the at least one third light source retaining planar surfaces differs from each other, and
wherein the mounting structure is configured to couple with at least one of the plurality of the light source retaining planar surfaces.

2. The light emitting heat dissipating structure of claim 1, wherein at least one of: the at least one first, the at least one second, or the at least one third light source retaining planar surfaces is configured to illuminate a short sub-field of illumination and another of the at least one first, the at least one second, or the at least one third surfaces light source retaining planar surfaces is configured to illuminate a distal sub-field of illumination.

3. The light emitting heat dissipating structure of claim 1, further comprising a lens including at least two optical lenses configured to direct light at different sub-areas.

4. The light emitting heat dissipating structure of claim 1, wherein at least one of: the size, the form, the number of light sources, light source power input, light output of the light sources, light source color temperature, light source color rendition index, orientation and/or tilt angle/s of one of the light source retaining surfaces is configured in relation to a corresponding sub-field of illumination.

5. The light emitting heat dissipating structure of claim 1, wherein the light emitted by at least one pair of light sources with dedicated lenses above coupled to the at least one light source retaining planar surface is substantially directed toward at least one of: contiguous and non-contiguous sub-areas of a corresponding sub-field.

6. The light emitting heat dissipating structure of claim 4, wherein at least one pair of light sources with dedicated lenses above are coupled to at least one of: first, second, and third light source retaining planar surfaces to direct light toward different sub-areas of illumination within their corresponding sub-fields.

7. The light emitting heat dissipating structure of claim 1, wherein at least one other light source retaining planar surface does not retain a light source.

8. The light emitting heat dissipating structure of claim 1, wherein the heat dissipating structure includes at least one of: electronic device enclosure and a mounting arm and/or surface.

9. A light emitting heat dissipating structure comprising:
light source retaining surfaces, light sources, optical lenses, wherein the light sources are coupled with the retaining surfaces defining a field of illumination comprising sub-fields of illumination including sub-areas of illumination,
wherein the first light source retaining surface is substantially parallel to one of the sub-fields defined as a short sub-field of illumination,
wherein at least one second light source retaining surface bisects the first light source retaining surface,
wherein the at least one of second light source retaining surfaces has an orientation and/or tilt angle different from third light source retaining surface,
wherein at least two light sources are coupled to each of the first light source retaining surface and to at least one of the second and third light source retaining surfaces,
wherein at least two optical lenses are disposed above each of the light sources,
and the light emitted from the first light source retaining surface illuminates a substantially different sub-area of illumination than the light emitted from at least one of the second and third light source retaining surfaces.

10. The light emitting heat dissipating structure of claim 9, wherein a unitarily formed lens comprises at least two optical lenses configured to direct light at different sub-areas.

11. The light emitting heat dissipating structure of claim 9, wherein different light sources type and/or quantity are coupled to at least two light source retaining surfaces.

12. The light emitting heat dissipating structure of claim 9, wherein at least one light source retaining surface does not retain a light source.

13. The light emitting heat dissipating structure of claim 9, wherein a cover is coupled to the heat dissipating structure.

14. The light emitting heat dissipating structure of claim 9, wherein a photovoltaic panel cover is coupled to the heat dissipating structure.

15. The light emitting heat dissipating structure of claim 9, wherein the heat dissipating structure is unitarily formed with at least one of: electronic device enclosure, an arm and a heat dissipating structure mounting surface.

16. A light emitting heat dissipating structure comprising:
light source retaining surfaces, light sources, an electronic device enclosure, and an arm and/or a mounting surface,
wherein the light source retaining surfaces include at least one first light source retaining surface disposed substantially horizontal,
wherein the light source retaining surfaces include at least one second light upwardly tilted light source retaining planar surface coupled with the at least one first light source retaining surface,
wherein the light source retaining surfaces include at least one third upwardly tilted light source retaining surface, at least in part, coupled with the at least one first light source retaining surface, wherein the at least one third light source retaining planar surface has an orientation that differs by at least 10 degrees from the at least the one second upwardly tilted light source,
wherein at least one light source is coupled to at least two of the at least one first, at least one second, and at least one third light source retaining planar surfaces, and
an electronic device enclosure unitary formed with at least one of the plurality of the light source retaining surfaces, the electronic device substantially aligned with the mounting structure.

17. The light emitting heat dissipating structure of claim 16, wherein at least one of: a mounting structure and a cover is/are coupled to the heat dissipating structure.

18. The light emitting heat dissipating structure of claim 16, wherein a J-box is incorporated to the mounting arm and/or the heat dissipating structure mounting surface.

19. The light emitting heat dissipating structure of claim 16, wherein the mounting structure is unitarily formed with at least one heat dissipating fin.

20. The light emitting heat dissipating structure of claim 16, wherein the heat dissipating structure with the coupled light sources is configured to be directing its light toward at least one of: horizontal and vertical surfaces.

21. A method of forming a light emitting heat dissipating structure, the method comprising:
providing a light emitting heat dissipating structure including a plurality of light source retaining planar surfaces of different tilt and orientation angles, a number of light sources, a number of lenses disposed above the light sources aiming the light at different directions, and a mounting surface configured for coupling with support structure, and
defining a fixed relation between one of the plurality of light source retaining planar surfaces and an illumination target for illumination, wherein the fixed relation is defined according to at least one of a light source mounting height, an area of the illumination target to be illuminated, a shape of the area, a location of the area in relation to the mounted height, a target light level, and a required uniformity ratio.
